(19) United States
(12) Patent Application Publication
(10) Pub. No.: US 2013/0054558 A1
(43) Pub. Date: Feb. 28, 2013

(54) UPDATED INFORMATION PROVISIONING

(71) Applicants: Mirza Muhammad Raza, Vancouver (CA); Wook Jin Chung, Sunnyvale, CA (US)

(72) Inventors: Mirza Muhammad Raza, Vancouver (CA); Wook Jin Chung, Sunnyvale, CA (US)

(73) Assignee: Microsoft Corporation, Redmond, WA (US)

(21) Appl. No.: 13/219,879

(22) Filed: Aug. 29, 2011

(51) Int. Cl. G06F 17/30

(52) U.S. Cl. 707/709; 707/769; 707/722; 707/E17.014; 707/E17.108

(57) ABSTRACT

One or more techniques and/or systems are disclosed for providing, in an automated fashion, updated information to a user regarding a topic indicated as being of interest to the user. At a first point in time, a first request for updated information on a first topic indicated as being of interest to a user can be received, such as from a website or service to which the user is connected. First updated information for the first topic can be requested from a data store that comprises updated information on one or more topics indicated as being of interest to the user. If the data store comprises the first updated information, the first updated information can be returned to the sender of the request, at the first point in time, such that the user may be presented with fresh content regarding a topic known to be of interest to the user.

### BACKGROUND

In a computing environment, a user may interact with an abundance of content while online (e.g., while connected to one or more networks, such as the Internet). A user may indicate an interest in an online topic in a variety of ways, such as by searching for the topic using a search website, navigating to an article about the topic, viewing a webpage comprising the topic, “liking” the topic on a social network site, blogging/micro-blogging about the topic, saving online content about the topic, and many more.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Currently, a user may interact with online content regarding topics of interest to the user primarily via a pull model (e.g., the content is pulled from a content provider in response to a user initiated action). When a user expresses an interest in a particular online topic, however, there does not seem to be mechanism that may understand that the user may desire to automatically receive updated information about the topic.

Accordingly, one or more techniques and/or systems are disclosed for providing updated information on a topic indicated as being of interest to a user. For example, the user may actively indicate an interest in a particular topic (e.g., by selecting or saving related content), and/or an indication of interest in a topic may be derived by other online activity of the user (e.g., searches, saves, “likes”, sites visited, topics discussed, etc.). Saved user topics (e.g., and/or information that is relevant thereto) can be updated by crawling a network of online content providers (e.g., the Internet) for updates, for example. Thus, when a user subsequently logs onto their device and/or online, updated information on a topic of interest can be automatically provided, for example.

In one embodiment of providing updated information, at a first point in time, a first request for updated information on a first topic indicated as being of interest to a user can be received. Further, in this embodiment, first updated information for the first topic can be identified in a data store at least for the user, where the data store comprises updated information on one or more topics indicated as being of interest to the user. Additionally, if the first updated information is identified in the data store, the first updated information on the first topic can be returned at the first point in time in response to the request.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for providing updated information.

FIG. 2 is a flow diagram illustrating an example embodiment where one or more portions of one or more techniques described herein may be implemented.

FIG. 3 is a flow diagram illustrating an example embodiment where one or more portions of one or more techniques described herein may be implemented.

FIG. 4 is a component diagram illustrating an exemplary system for providing updated information.

FIG. 5 is a component diagram illustrating an example embodiment where one or more systems described herein may be implemented.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

As provided herein, updated information regarding one or more topics indicated as being of interest to a user may be presented to a user in an automated fashion. For example, when the user interacts with online content or digital media (e.g., web pages, search results, web videos, etc.) the interaction and associated topic can be detected (e.g., using a type of “Save” action), categorized and stored, such as in a cloud-based “personal space” for the user. Updated or additional information relating to the topic can be retrieved online (e.g., by crawling sites), and presented to the user when they subsequently log on, for example. As an example, information related to an event/topic indicated as being of interest to a user can be updated to a calendar for the user, such as to show ticket prices and/or availability, show times, venue information, etc.

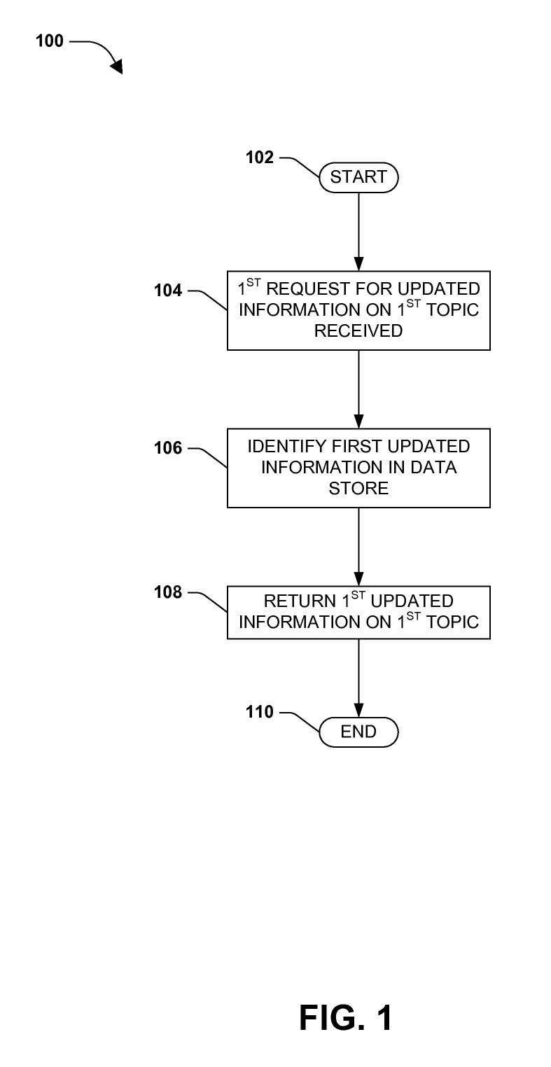

FIG. 1 is a flow diagram illustrating an exemplary method 100 for providing updated information. The exemplary method 100 begins at 102 and involves receiving, at a first point in time, a first request for updated information on a first topic indicated as being of interest to a user, at 104. As an example, the user may navigate to a web site, and/or initiate an application (e.g., on a device used by the user, or a web-based application), which can request updated information for the user's interests. As an illustrative example, the user may have previously indicated an interest in a movie that is to be released sometime later in the year, such as by querying the movie title in an online search engine. When the user subsequently logs on to that search engine or another site or application, etc., the search engine, site, application, etc. may request updated information for the movie given the user's previous indication of being interested in the movie (e.g., to identify a release date, new trailers, or other updated information).

At 106, first updated information on the first topic is identified in a data store, portions of which may be associated with the user (e.g., and/or with other users, and/or other portions of the data store may be associated with other users). As an example, information related to the first topic may be stored in the data store (e.g., a cloud-based data store) and linked to the user. Further, in this example, the information on the first topic may be periodically updated (e.g., on a regular basis or when requested), such as by retrieving online updates to the topic.

At 108, if the first updated information is identified in the data store, the first updated information is returned in response to the request, at the first point in time. As an example, at the first point in time (e.g., when the user logs on to their device after previously indicating an interest in the movie), an application on the user's device or the website to which the user navigates can send the request for updated interest information linked to the user, and, in response, can receive the first updated information. Further, the sender of the request can integrate the updated information into local content (e.g., on the website or application) and present it to the user. As an illustrative example, the first updated information may comprise a new release date of a movie indicated as being of interest to the user, along with a link to new trailers for that movie. In this example, the user's calendar (e.g., local or web-based) may automatically create a reminder for the movie release date, and/or the user's home page may be customized to display a scroll bar, pop-up, or some other web-application that indicates the link to the trailer, or displays the trailer on the page.

Having returned the first updated information at the first point in time, the exemplary method 100 ends at 110.

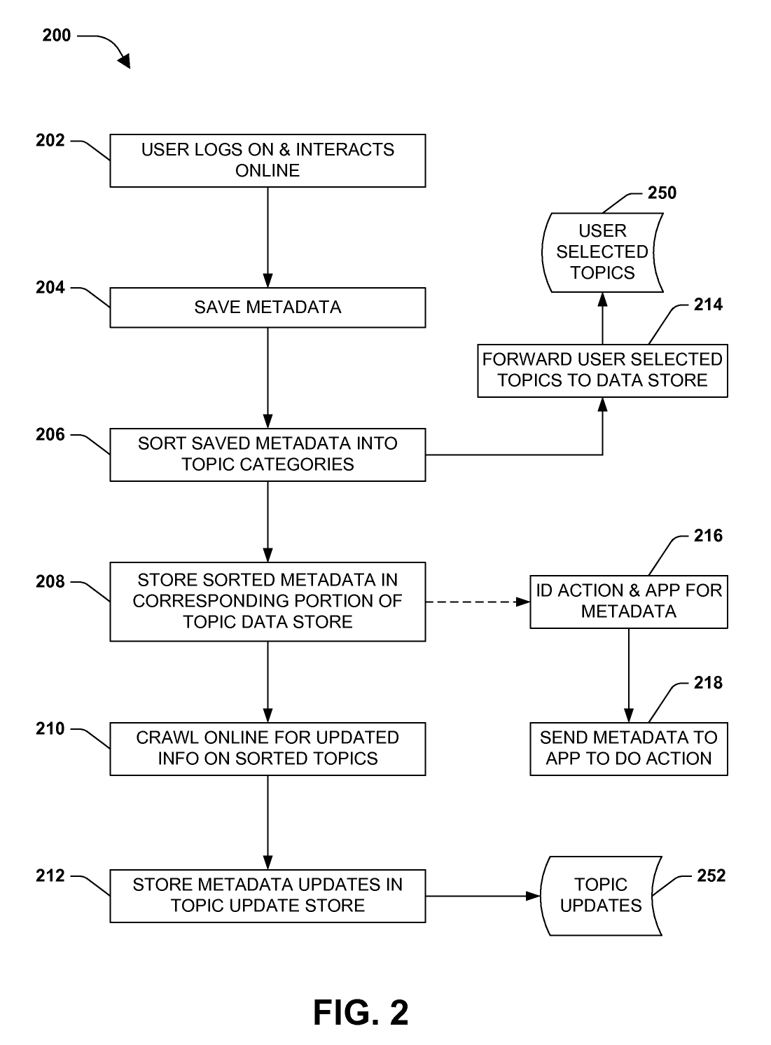

FIG. 2 is a flow diagram illustrating an example embodiment 200, where one or more portions of one or more techniques described herein may be implemented. At 202 a user logs on (e.g., to a device and/or a network) and interacts with online content. In one embodiment, logging on can comprise logging on to the device (e.g., startup), opening an application, opening a browser in the device, and/or some way for the user to be identified (e.g., IP address, phone number, network location, etc.), for example, so that one or more topics indicated as being of interest to the user can be found and/or recalled.

Further, in one embodiment, the user may interact with online content in a manner that indicates some interest by the user, in the content. As an example, a query that the user enters into an online search site can indicate an interest in the query terms; saving a news article or blog post on a subject may indicate an interest in the subject of the article, the author and/or the site posting the article; “liking” a video of an actor may indicate an interest in the video and/or actor; and/or downloading or printing a coupon from a sale may indicate an interest in a product and/or retailer, etc.

It will be appreciated that the indication of interest is not limited to the embodiments and examples described herein. It is anticipated that those skilled in the art may devise alternate “interest indicators” for online content/topics, and the embodiments described herein are merely meant to provide illustrative examples of how one or more topics may be identified where those topics are indicated as being of interest to the user.

At 204 in the example embodiment, metadata associated with topics indicated as being of interest to the user can be saved. It may be appreciated that a topic may be indicated as being of interest to a user based upon content selected by a user. Accordingly, metadata that is saved may comprise, inter alia, information about user selected content, such as an identifier (e.g., topic name), a type of content (e.g., text, video, image, link, web-page, etc.), a date the content was selected, a type of interaction that selected the content (e.g., search, selection, viewing, saving, etc.), and an online location for the selected content (e.g., a URI). In one embodiment, the metadata can be stored in a remote data store, such as a cloud-based storage service, that can be linked to the user.

At 206, the saved metadata can be sorted into one or more topic categories (e.g., based upon one or more categories into which corresponding user selected topics (from which the metadata is derived, or rather with which the metadata is associated) may be sorted, such as movies, people, events, news, for example). As an example, for user selected content that comprises a movie title as the topic of interest, metadata can be sorted into a movie topic category and a people topic category. For a saved posting from a new blog site about a new product being released as the topic of interest, metadata may be sorted into a news topic category and an events topic category. For an interaction with online content for an upcoming concert as the topic of interest, metadata may be sorted into an events topic category and a people topic category. Of course these are merely examples and the instant application is not intended to be limited thereto.

Further, in one embodiment, a topic category can comprise or correspond to a topic type that may provide additional, supplemental, etc. information, that may influence how often information on this topic is to be updated, for example. As an illustrative example, the user selected content or topic of interest may comprise Spend-It, which is known to be a mid-to-high range department store. A corresponding topic category for Spend-It may comprise retail stores, but may also comprise a topic type for sales, deals, coupons for Spend-It, products sold at Spend-It, etc. In this example, information on the topic of Spend-It (indicated as being of interest to the user) may be updated weekly when new coupons are issued for products sold at Spend-It, for example.

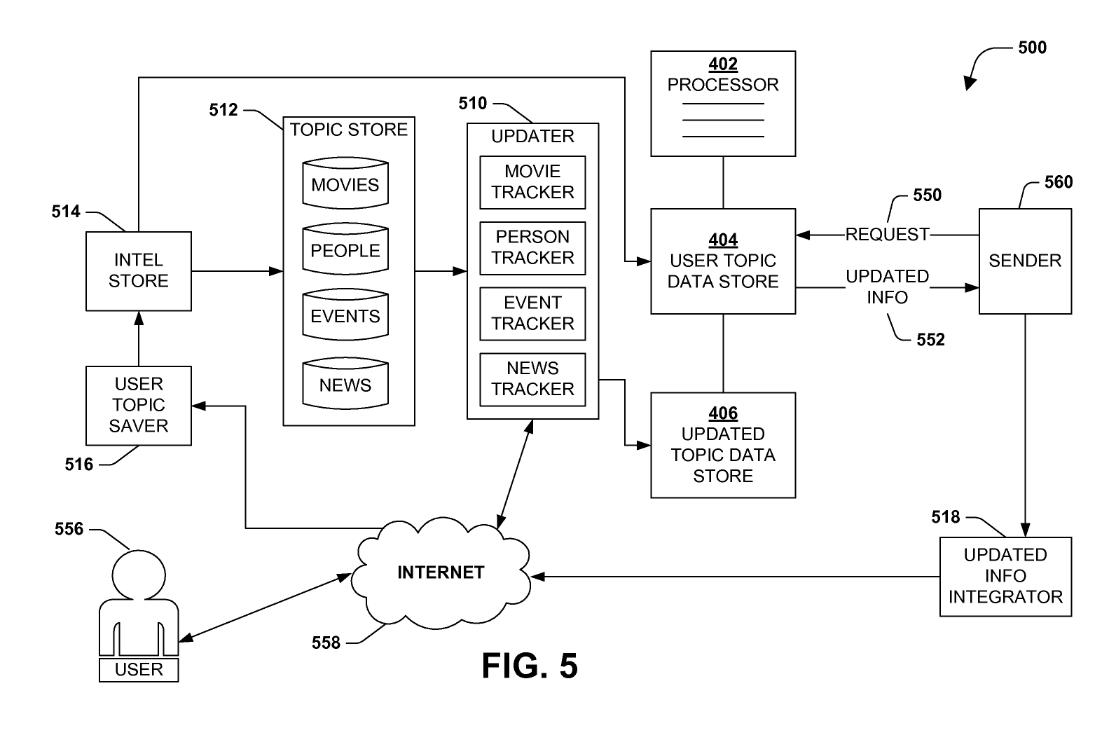

At 208 in the example embodiment 200, the sorted metadata can be stored in a corresponding portion (e.g., category data store) of a topic data store (e.g., topic storage component 512 of FIG. 5). In this example, the sorted metadata can be stored in a corresponding portion of the topic data store if such a portion is already present, or a new portion (e.g., new category data store) can be created if needed. In one embodiment, the topic data store can comprise a cloud-based storage service for storing the data remotely from a user device.

At 214, the user selected topics can be forwarded to a data store (e.g., user topic data store component 404 of FIG. 5). The data store can comprise a remote, cloud-based storage service that stores the user selected topics 250, which may be linked to the user (e.g., in a database listing topics for respective users). It may be appreciated that the user selected topics 250 stored in the data store may be linked to other users as well (e.g., so that updated information on these topics may be provided to other users (who have also indicated an interest in these topics) as well, such as when the other users perform respective subsequent log on operations).

At 210, one or more online network sites can be crawled (e.g., continually or periodically) for one or more updates to the metadata associated with the topics indicated as being of interest to the user. In one embodiment, such crawling for updated information may be performed while the user is offline so there is little to no delay in presenting updated information to the user when the user logs on (at a subsequent point in time). It may be appreciated that such crawling is efficient at least because merely content related to the one or more topics indicated as being of interest to the user is crawled (e.g., reducing the amount of crawling that is performed and/or making the crawling that is performed targeted to user interests).

As an illustrative example, a user may select “Celebrity 1” to follow on a social network or micro-blogging site and/or perform a search on Celebrity 1, thus indicating that this celebrity is a topic of interest to the user. In this example, updates to Celebrity 1 related information may be identified by crawling the Internet (e.g., blogs, micro-blogs, social networks, etc.) such that recent images, upcoming TV show appearances, movie appearances, other news, etc. regarding Celebrity 1 may be identified.

As another illustrative example, the user may select Seattle as their current location (e.g., where they reside), and Seattle may thus comprise a topic indicated as being of interest to the user. In this example, local updates can be identified, such as newly published coupons around town or local events. Further, in this example, the updates may comprise weather and traffic information, a new restaurant opening that received great reviews, or events at local venues (e.g., concerts, movies, shows). As another illustrative example, the user may indicate an interest in New York (e.g., through searches, etc.), while still living in Seattle such that New York becomes a topic indicated as being of interest to the user. Updates to this topic can comprise plane ticket information (e.g., prices, flights, dates, etc.), weather from New York and/or hotel deals and similar services a non-resident may find useful.

At 212 in the example embodiment 200, metadata for one or more updates 252 (e.g., updated information) can be stored in a topic update store (e.g., updated topic data store component 406 of FIG. 5). As an example, the topic update store may comprise a data base that links respective topics indicated as being of interest to the user and stored in the data store (e.g., user topic data store component 404 of FIG. 5) to corresponding updates 252 identified by crawling the online network sites. In this way, for example, the topic update store (e.g., updated topic data store component 406 of FIG. 5) may comprise up-to-date information for topics that are of interest to the user.

In one embodiment, at 216, a desired action that is associated with the sorted metadata can be identified. Further, in this embodiment, an application that is associated with the desired action can be identified. As an example, the topic indicated as being of interest to the user (e.g., selected online content) may be identified as an upcoming event (e.g., movie, concert, show, game). In this example, the identified action for the topic and thus associated metadata may comprise adding the event to the user's calendar, monitoring ticket prices, posting to a social network site, finding a reasonably priced place to park, etc. Further, in this example, the appropriate application (e.g., locally on the user's device, or at a remote web-application) can be identified for performing the identified action, such as the users local calendar application or a web-based calendar, an online ticket broker application, and/or one or more social network sites for the user.

At 218, the metadata can be forwarded to the identified application, which may be able to perform the identified action. As an illustrative example, for a theatrical performance that may sell out quickly. A ticket monitoring application may be identified, which can monitor ticket prices on the event (e.g., based upon performance data metadata) and identify a lowest price ticket remaining for the performance on a particular date. Further, as tickets start selling out for certain days, the application may be able to warn the user of an impending sell out.

As another illustrative example, the user may have selected a specific flight (e.g., from Seattle to New York) as a topic of interest. In this example, a travel-related application may be identified that shows schedules, real-time flight status, airport parking fees, etc. Additionally, the sorted metadata may be sent to an airline's online application that can customize an experience with the airline and/or obtain frequent flyer miles, for example.

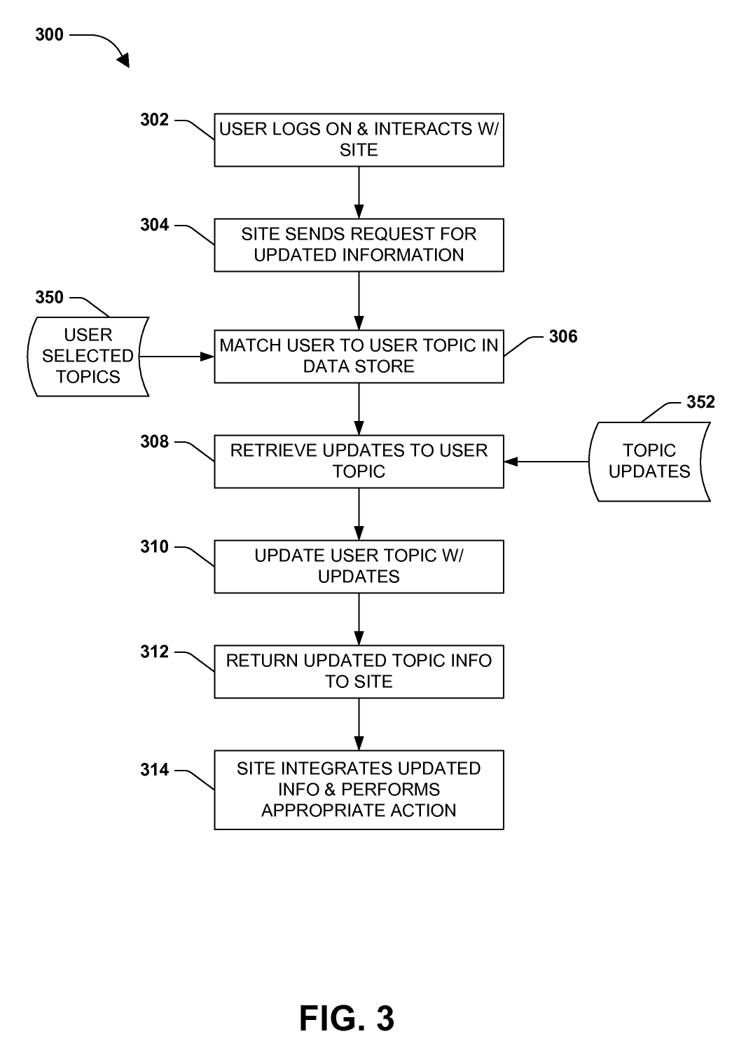

FIG. 3 is a flow diagram illustrating an example embodiment 300 where one or more portions of one or more techniques described herein may be implemented. At 302, the user logs on to their device, and/or online, and interacts with an online site (e.g., website) or service (e.g., a local application linked with an online service). At 304, the site or service can send a request for updated information on a topic indicated as being of interest to the user (e.g., any topic previously identified as being of interest to the user so that the user may be presented with at least some fresh content on a topic of interest to the user). As an example, the user may log on to their device, which activates the users local organizer (e.g., comprising an email application, calendar, tasks, etc.) that is linked to an online service (e.g., a remote server providing emails, calendar updates, etc.). In this example, the local organizer application or the linked online service may send a request for updated information on one or more user topics for which the user has indicated an interest (e.g., user selected content).

At 305, the user can be matched to one or more user topics in a data store (e.g., user topic data store component 404 of FIG. 5). As an example, one or more user selected topics 350 linked to the user may be stored in the data store (e.g., from 214 in FIG. 2). In one embodiment, the request can comprise a user identification for the user (e.g., a registered UserID, IP address, or some other identifier for the user), for example, and the user identification may be used to match the user to the one or more user selected topics 350 stored in the data store (e.g., where the data store (e.g., user topic data store component 404 of FIG. 5) may store topics indicated as being of interest to this user as well as topics indicated as being of interest to one or more other users, where there may be at least some overlap such that more than one user may be interested in a same topic (e.g., one topic has multiple users associated therewith)). In one embodiment, the request may also comprise an identifier for one or more particular topics (e.g., a first topic) indicated as being of interest to the user, for example, where the sender of the request wishes to receive updated information on the one or more particular topics (e.g., related to content for the site or service logged onto by the user, such that fresh content presented to the user is relevant to the online experience within which the user is presently engaged).

At 308, if at least one match is found (e.g., there is a topic in the data store for/linked to the user) a request can be made to a topic update store (e.g., updated topic data store component 406 of FIG. 5) for updated information on the matched user selected topics. If updated information is found for a matched user selected topic, then that topic can be updated to comprise the updated information, at 310.

In one embodiment, a first request, at a first point in time, can comprise a request for first updated information on a first topic indicated as being of interest to the user. The first topic can be matched to a user selected topic in the data store (e.g., user topic data store component 404 of FIG. 5), and one or more updates for the first topic can be retrieved from the topic update store (e.g., updated topic data store component 406 of FIG. 5), which may or may not be comprised within and/or be a component part of the data store. In this embodiment, the first topic, matched to the user selected topic in the data store, can be updated with the one or more updates for the first topic, resulting in the first updated information on the first topic.

At 312 of the example embodiment 300, one or more updated user selected topics can be returned to the sender of the request (e.g., the website or service). In one embodiment, the request can comprise a sender identification for the sender of the request, and/or a universal resource identifier (URI) for responding to the request. For example, a sender ID may be used to verify that the sender is authorized to receive updated user selected topic information (e.g., using a sender registration process); and/or may be linked in a database to identify a location for returning the response to the request. As another example, the URI can be used to identify a location for sending the response to the request, where the response may be directed to an alternate location (e.g., alternate from the request origin).

At 314, the site or service may integrate the updated information for the one or more user selected topics into content for the site or service and/or perform an appropriate/desired action associated with the updated information. As an example, the users local organizer may send the request, the user can be matched to one or more topics, and updated information can be provided to the organizer (e.g., through the online service) for the one or more topics. In this example, the organizer may integrate event information into the user's calendar and display it to the user.

As an illustrative example, the user may have indicated that Caribbean cruises are a topic of interest to the user (e.g., by searches, navigating to cruise sites, blogging about cruises, etc.). When the user logs on to their home page (e.g., on the Internet) the home page may comprise a banner that routinely presents updated prices on Caribbean cruises. Further, in this example, when the user logs onto their device, a weather gadget on the desktop may begin displaying weather and news from the Caribbean. Additionally, in this example, if the user lives in Seattle the user may routinely be presented with updated information on airfare between Seattle and ports from which Caribbean cruises depart.

As another illustrative example, if the user saves a particular gaming console on a wish list of a retail website, thus indicating that the gaming console if a topic of interest to the user, the user may be presented with updated information on new releases of the console, pricing of the console, accessories for the console, etc. through the site or service sending the request for updated information. As another illustrative example, the user may indicate an interest in a particular clothing line, and updates about the clothing line, and similar clothing lines, may be identified. In this example, when the user logs onto a particular site or service, they may be shown updated information on deals, sales events, and store locations for the clothing line as well as on similar brands.

In one aspect, the user may log onto a site or service at different times, and may be shown (e.g., or some other action may occur) different updates (e.g., up-to-date information) to one or more topics indicated as being of interest to the user. In one embodiment, a second request may be received at a second point in time, for updated information on the first topic (e.g., when the user subsequently, to the first point in time, interacts with the site or service sending the request). In this embodiment, if the first topic is (e.g., continues to be) identified in the data store (e.g., matched to the user), second updated information (if present) on the first topic can be returned at the second point in time. As an example, the second updated information on the first topic may comprise more up-to-date information than that of the first updated information on the first topic.

Additionally, in one embodiment, a first request may be received at a third point in time, for updated information on a second topic (e.g., at a same or different time than that of the first point in time when the first request for updated information on the first topic was made and/or the second point in time when the second request for updated information on the first topic was made). In this embodiment, if the second topic is identified in the data store (e.g., matched to the user), first updated information (if present) on the second topic can be returned at the third point in time. In one embodiment, a second request may be received at a fourth point in time, for updated information on the second topic (e.g., at a same or different time than that of the first point in time and/or the second point in time, but subsequent to the third point in time). In this embodiment, if the second topic is (e.g., continues to be) identified in the data store, second updated information (if present) on the second topic can be returned at the fourth point in time.

As an illustrative example, a request may comprise a request for the first updated information on the first topic and/or the first updated information on the second topic (e.g., comprising the first point in time and/or the third point in time). Further, in this example, a subsequent request may comprise a request for the second updated information on the first topic and/or the second updated information on the second topic (e.g., comprising the second point in time and/or the fourth point in time). It will be appreciated that a second request for updated information on a topic may be subsequent to the first request for updated information on the same topic. However, requests for updated information on different topics may be received at a same or at different points in time.

In another aspect, updated information provided in response to the request may be updated at a time of the request, or at a time before the request. In one embodiment, the first updated information on the first topic can be updated into the data store at the first point in time or at a time before the first point in time. In one embodiment, the second updated information on the first topic can be updated into the data store at the second point in time or a time before the second point in time. In one embodiment, the first updated information on the second topic can be updated into the data store at the third point in time or a time before the third point in time. In yet another embodiment, the second updated information on the second topic can be updated into the data store at the fourth point in time or a time before the fourth point in time.

A system for providing up-to-date information to a user on one or more topics indicated as being of interest to the user may be devised. For example, when a user goes online (e.g., via a browser or a network connected application) they may interact with content that can indicate topics of interest to the user. The user selected topics (e.g., indicated as being of interest to the user via user interaction with online content) can be categorized and updated by crawling network sites for updated information (e.g., up-to-date information), for example. When the user subsequently logs onto their device, website or a network connected application, the updated information can be provided to the user, for example, by integrating it with content from the site, and/or performing an appropriate action (e.g., updating a calendar).

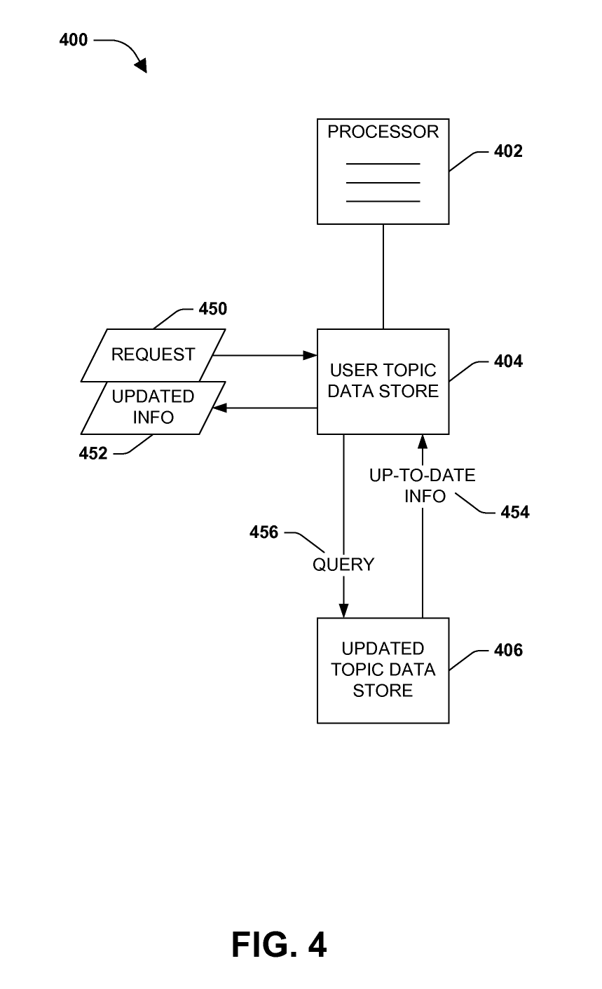

FIG. 4 is a component diagram illustrating an exemplary system 400 for providing updated information. The exemplary system 400 comprises a computer-based processor 402 that is configured to process data for the system. The processor 402 is operably coupled with a user topic data store component 404. The user topic data store component 404 is configured to identify a first user selected topic in response to a first request 450 for up-to-date topic information for the user. Further, the user topic data store component 404 is configured to return first up-to-date information 452 on the first user selected topic in response to the first request 450.

The exemplary system 400 further comprises an updated topic data store component 406 that is operably coupled with the user topic data store component 404. The updated topic data store component 406 is configured to provide the first up-to-date information 454 on the first user selected topic to the user topic data store component 404 based on a first query 456 from the user topic data store component 404.

As an example, a site or service, to which the user may have connected, can send a request 450 for up-to-date information on one or more topics that may be of interest to the user (e.g., any topics previously indicated as being of interest to the user so that the user is presented with at least some fresh content on a topic of interest to the user). The user associated with the request can be matched to one or more user topics in the user topic data store 404. If one or more topics previously indicated as being of interest to the user are found in the user topic data store, then the user topic data store component 404 can query 456 the updated topic data store component 406 for any available updates to these topics. The updated topic data store component 406 can return any available updates on these topics which may have been previously retrieved (or are retrieved on the fly) by crawling network sites for updates on these topics. The user topic data store component 404 can update these topics with the updated information, and return the up-to-date information to the sender of the request (e.g., so that the user is presented with up to date information on a topic of interest to the user). If there is no match in the user topic data store 404 for the one or more topics identified in the request 450, then no information may be provided in response to the request 450. Similarly, if there is a match, but there is no updated information on these topics in the updated topic data store component 406, then the user topic data store 404 may return whatever information is presently available for at least some of one or more of these topics.

In one embodiment, the updated topic data store component 406 can be configured to provide second up-to-date information 454 on the first user selected topic based on a second query 456 from the user topic data store component 404. In this embodiment, the second query 456 may be in response to a second request 450 for up-to-date topic information for the user. For example, the user may log onto the site or service a second time, and the site or service may send the second request in order to get up-to-date information on one or more topics of interest to the user, where the updated information may have changed (e.g., been further updated) since the first request.

In another embodiment, the updated topic data store component 406 can be configured to provide first up-to-date information 454 on a second user selected topic based on a third query 456 from the user topic data store component 404. In this embodiment, the third query 456 may be in response to a third request 452 for up-to-date topic information for the user. Further, the updated topic data store component 406 can be configured to provide second up-to-date information 454 on the second user selected topic based on a fourth query 456 from the user topic data store component 404. In this embodiment, the fourth query 456 may be in response to a fourth request 450 for up-to-date topic information for the user. For example, the site or service may request up-to-date information on more than one topic of interest to the user at a same or at different times.

FIG. 5 is a component diagram illustrating an example embodiment 500 where one or more systems described herein may be implemented. In this example, an extension of FIG. 4 is provided and thus description of elements, components, etc. described with respect to FIG. 4 may not be repeated for simplicity. In the example embodiment 500, a user selected topic saving component 516 can be configured to determine when a user 556 selects a topic. Further, the user selected topic saving component 516 can be configured to identify an indication of the user 556 selecting the topic, which is indicative of the topic being of interest to the user 556. Additionally, the user selected topic saving component 516 can be configured to forward the user selected topic to an intelligent storage component 514.

For example, the user 556 may navigate to a search-based website on the Internet 558, enter a query term, and perform a web-based search for the query term. In this example, when the user enters the query term and/or performs the search, the user selected topic saving component 516 may determine the user is interested in a particular topic, as indicated by the query term and/or search. As another example, the user may indicate that they “like” an article about a particular topic, such as on a social network site. In this example, the “like” action can indicate the selection of the topic by the user, and the selected topic of interest may be forwarded to the intelligent storage component 514.

In the example embodiment 500, a topic storage component 512 can be configured to selectively store metadata associated with the topic in category data stores (e.g., movies, people, events, news) for one or more topic categories. For example, the one or more topics selected by the user 556 (forwarded by the user selected topic saving component 516) can be sorted into one or more categories by the intelligent storage component 514. Further, in this example, metadata (e.g., title, date, text, origin, tags, etc.) associated with the sorted user selected topics can be stored in respective category data stores (e.g., movies, people, events, news) corresponding to the respective categories into which the user selected topics were sorted by the intelligent storage component 514.

In addition to categorizing the one or more user selected topics into the one or more topic categories to facilitate the selective metadata storage into category data stores, the intelligent storage component 514 can be configured to forward the one or more user selected topics to the user topic data store component 404 to populate the user topic data store. For example, one or more topics that are determined to be of interest to the user (by the user selected topic saving component 516) can be forwarded to the user topic data store component 404. In the example embodiment 500, an updating component 510 operatively coupled to the topic storage component 512 can be configured to crawl one or more online network sites (e.g., on the Internet 558) for one or more updates for one or more user selected topics to populate the updated topic data store component 406. It may be appreciated that the crawling may be efficient as the network sites are crawled merely for content related to the one or more topics indicated as being of interest to the user (e.g., as other updated information on the sites may not be relevant as it does not relate to topics that are indicated as being of interest to the user).

Further, an updated information integration component 518 can be configured to integrate first up-to-date information 552 on a first user selected topic into content from a sender 560 of a first request 550. For example, the sender 560 can send a first request 550 for updated information a first topic indicated as being of interest to the user 556 (e.g., when the user revisits a website). The user topic data store component 404 can match the first topic in the first request to a first user selected topic stored in the user topic data store component 404, and query the updated topic data store component 406 for up-to-date information on the first topic. The updated topic data store component 406 may comprise an update for this first topic (as provided by the updating component 510 (e.g., from crawling the Internet 558)), which can be used to update corresponding information for the first topic in in the user topic data store component 404. This first up-to-date information 552 on the first user selected topic can be returned to the sender, which may utilize the updated information integration component 518 to present this first up-to-date information to the user 556 (e.g., by integrating the first up-to-date information 552 into a website on the Internet 558 (e.g., replacing existing/stale content on the first topic with the first up-to-date information 552)).

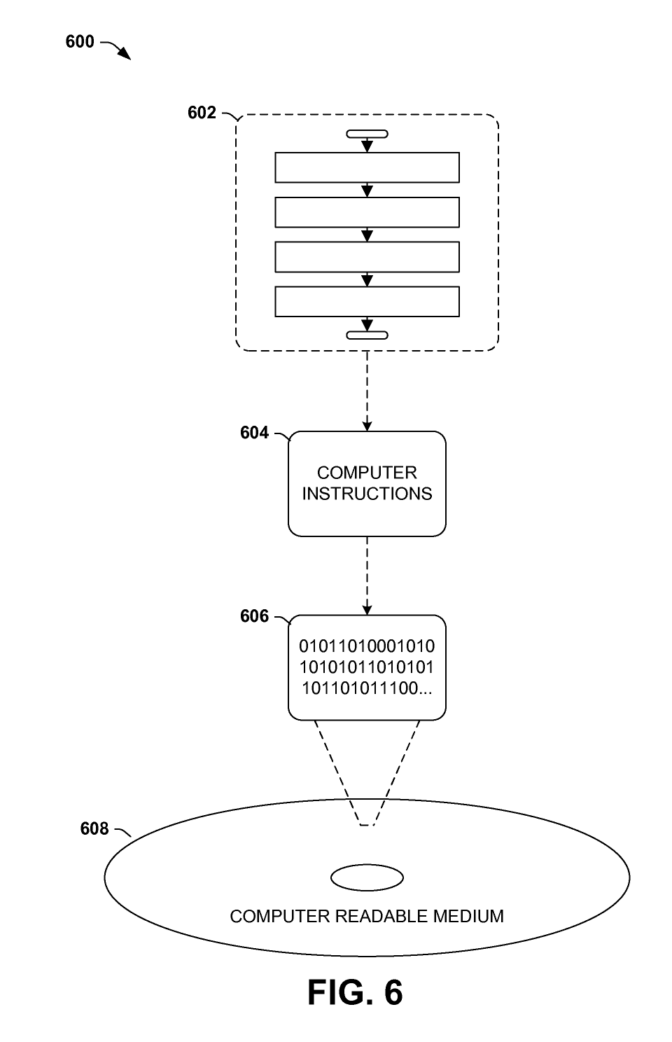

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 608 (e.g., a CD-R, DVD-R, or a platter of a hard disk drive), on which is encoded computer-readable data 606. This computer-readable data 606 in turn comprises a set of computer instructions 604 configured to operate according to one or more of the principles set forth herein. In one such embodiment 602, the processor-executable instructions 604 may be configured to perform a method, such as at least some of the exemplary method 100 of FIG. 1, for example. In another such embodiment, the processor-executable instructions 604 may be configured to implement a system, such as at least some of the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

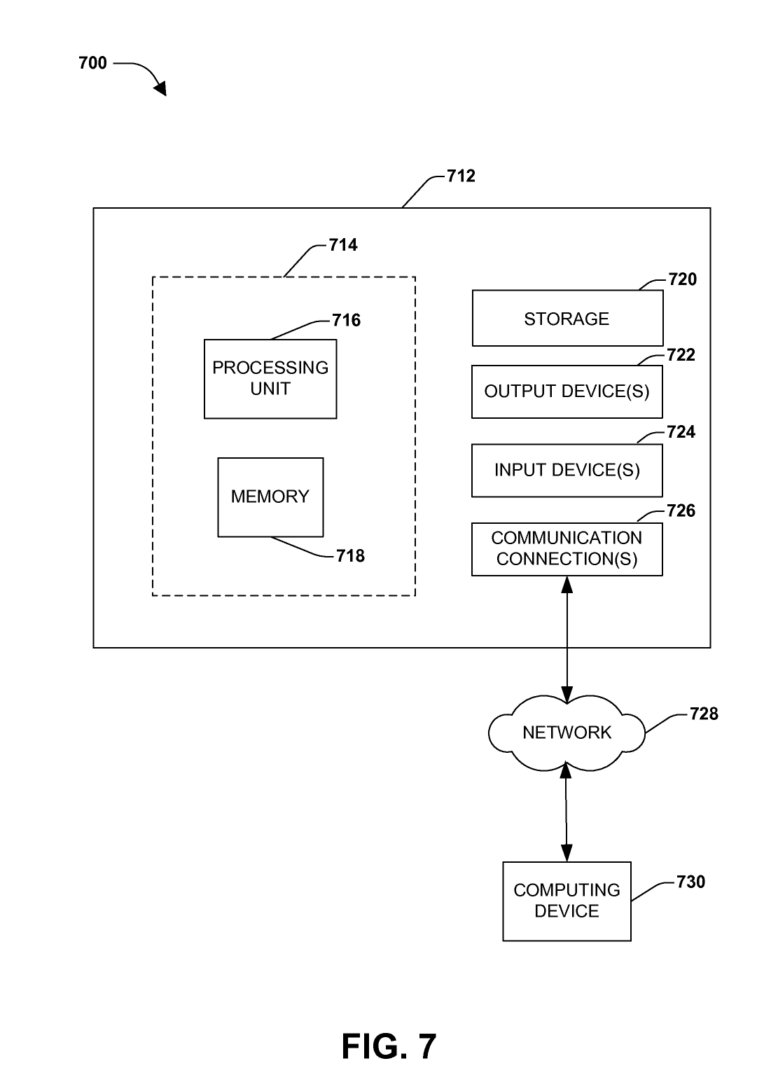

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for providing updated information, comprising:
receiving, at a first point in time, a first request for updated information on a first topic indicated as being of interest to a user; and
returning, at the first point in time, first updated information on the first topic if found in a data store at least for the user, the data store comprising updated information on one or more topics indicated as being of interest to the user, at least some of at least one of the receiving and the returning implemented at least in part via a processing unit.

2. The method of claim 1, comprising one or more of:
returning, at a second point in time, second updated information on the first topic if found in the data store in response to receiving, at the second point in time, a second request for updated information on the first topic;
returning, at a third point in time, first updated information on a second topic indicated as being of interest to the user if found in the data store in response to receiving, at the third point in time, a first request for updated information on the second topic; and
returning, at a fourth point in time, second updated information on the second topic if found in the data store in response to receiving, at the fourth point in time, a second request for updated information on the second topic.

3. The method of claim 2, comprising one or more of:
updating the first updated information on the first topic into the data store at the first point in time or a time before the first point in time;
updating the second updated information on the first topic into the data store at the second point in time or a time before the second point in time;
updating the first updated information on the second topic into the data store at the third point in time or a time before the third point in time; and
updating the second updated information on the second topic into the data store at the fourth point in time or a time before the fourth point in time.

4. The method of claim 1, comprising updating the data store to comprise updated information by crawling one or more online network sites merely for content related to the one or more topics indicated as being of interest to the user.

5. The method of claim 1, the first updated information on the first topic comprising updated information obtained from online content related to the first topic from a topic update store, comprised in the data store, which stores updates for one or more online topics.

6. The method of claim 1, returning the first updated information on the first topic comprising one or more of:
matching the first topic to a stored user topic in the data store;
retrieving one or more updates for the first topic from a topic update store, comprised in the data store; and
updating the first topic with the one or more updates for the first topic resulting in the first updated information on the first topic.

7. The method of claim 1, comprising storing one or more topics indicated as being of interest to the user in the data store, the one or more stored topics comprising metadata associated with online content selected by the user.

8. The method of claim 1, comprising one or more of:
sorting metadata associated with online content selected by the user into one or more topic categories; and
storing sorted metadata in a corresponding portion of a topic data store for the respective one or more topic categories.

9. The method of claim 8, comprising crawling one or more online network sites for one or more updates to the metadata associated with the online content selected by the user.

10. The method of claim 8, comprising one or more of:
identifying a desired action associated with the sorted metadata;
identifying an application associated with the desired action; and
providing the sorted metadata to the identified application to perform the desired action.

11. The method of claim 1, receiving the first request comprising receiving one or more of:
a user identification for the user;
an identifier for the first topic indicated as being of interest to the user;
a sender identification for a sender of the request; and
a universal resource identifier for responding to the request.

12. The method of claim 1, comprising receiving the first request in response to the user connecting to an online network site comprising a connection to a sender of the request.

13. A system for providing updated information, comprising:
a computer-based processor configured to process data for the system;
a user topic data store component, operably coupled with the processor, configured to:
identify a first user selected topic in response to a first request for up-to-date topic information for the user; and
return first up-to-date information on the first user selected topic in response to the first request; and
an updated topic data store component, operably coupled with the user topic data store component, configured to provide the first up-to-date information on the first user selected topic to the user topic data store component based on a first query from the user topic data store component.

14. The system of claim 13, the updated topic data store component configured to provide one or more of:
second up-to-date information on the first user selected topic based on a second query from the user topic data store component, the second query in response to a second request for up-to-date topic information for the user;
first up-to-date information on a second user selected topic based on a third query from the user topic data store component, the third query in response to a third request for up-to-date topic information for the user; and
second up-to-date information on the second user selected topic based on a fourth query from the user topic data store component, the fourth query in response to a fourth request for up-to-date topic information for the user.

15. The system of claim 13, comprising a user selected topic saving component configured to perform one or more of:
determine when a user selects a topic;
identify an indication of the user selecting the topic indicative of the topic being of interest to the user; and
forward the user selected topic to an intelligent storage component.

16. The system of claim 15, comprising a topic storage component configured to selectively store metadata associated with the topic in category data stores for one or more topic categories.

17. The system of claim 16, the intelligent storage component configured to perform one or more of:
categorize the topic into one or more topic categories to facilitate the selective metadata storage; and
forward the topic to the user topic data store component to populate the user topic data store.

18. The system of claim 13, comprising an updating component configured to crawl one or more online network sites for one or more updates for one or more user selected topics to populate the updated topic data store component.

19. The system of claim 13, comprising an updated information integration component configured to integrate the first up-to-date information on the first user selected topic into content from a sender of the first request.

20. A computer readable medium comprising computer executable instructions that when executed via a processing unit on a computer perform a method for providing updated information, comprising:
storing one or more topics indicated as being of interest to a user in a data store;
updating the one or more stored topics in the data store with updated information by crawling one or more online network sites merely for online content related to the one or more topics indicated as being of interest to the user;
receiving, at a first point in time, a first request for updated information on a first topic indicated as being of interest to a user;
returning, at the first point in time, first updated information on the first topic if found in the data store;
receiving, at a second point in time, a second request for updated information on the first topic;
returning, at the second point in time, second updated information on the first topic if found in the data store;
receiving, at a third point in time, a first request for updated information on a second topic indicated as being of interest to the user;
returning, at the third point in time, first updated information on the second topic if found in the data store, the third point in time being the same or different than the first point in time and being the same or different than the second point in time;
receiving, at a fourth point in time, a second request for updated information on the second topic; and
returning, at the fourth point in time, second updated information on the second topic if found in the data store, the fourth point in time being the same or different than the first point in time and being the same or different than the second point in time.
